(19) United States
(12) Patent Application Publication
(10) Pub. No.: US 2024/0102731 A1
(43) Pub. Date: Mar. 28, 2024

(54) MOBILE REFRACTANCE WINDOW DRYER

(71) Applicant: E. & J. Gallo Winery, Modesto, CA (US)

(72) Inventors: Jorge Ortiz, Fresno, CA (US); Dan Burgess, Clovis, CA (US)

(21) Appl. No.: 18/473,522

(22) Filed: Sep. 25, 2023

Related U.S. Application Data
(60) Provisional application No. 63/409,534, filed on Sep. 23, 2022.

(51) Int. Cl. F26B 3/20; F26B 17/02; F26B 23/10

(52) U.S. Cl. CPC F26B 3/20; F26B 17/023; F26B 23/10

(57) ABSTRACT

Methods and apparatus for drying harvested products using a mobile drying system are disclosed. According to some embodiments, a refractance window dryer is implemented on a mobile platform that includes two mobile units (e.g., trailers or transportable skid mounted assemblies) that may be transported to a remote location (e.g., at a harvest location). A first mobile unit may include a refractance window dryer module, and a second mobile unit may include utility equipment that supports operation of the refractance window dryer module.

### CROSS-REFERENCE TO RELATED APPLICATIONS

This application claims the benefit of U.S. Provisional Patent Application No. 63/409,534, filed Sep. 23, 2022, the entire contents of which are incorporated by reference herein.

### FIELD OF TECHNOLOGY

The present disclosure relates generally to refractance window dryer technology and, more specifically, to an apparatus and method for providing refractance window dryer capabilities on a mobile platform.

### BACKGROUND

In many instances, degradation of a plant material or product, such as fruits, vegetables, slurries, algae, and the like, commences immediately after harvesting. Consequently, immediate refrigeration at the harvesting location, storage facility, and/or while the product is being transported between locations is generally required to prevent or minimize product degradation. The need for constant refrigeration significantly increases the cost and logistics complexity associated with storing and distributing harvested products.

### SUMMARY OF THE DISCLOSURE

Methods and apparatus for drying harvested products at or near a harvest location using a mobile refractance window dryer are disclosed. According to some embodiments, the mobile refractance window dryer is implemented on a mobile platform that includes two mobile units (e.g., trailers or transportable skid mounted assemblies) that may be transported to a remote location (e.g., at the harvest location). A first mobile unit may include a refractance window dryer module, and a second mobile unit may include utility equipment that supports operation of the refractance window dryer module.

The methods and apparatus disclosed herein have several advantages over previous methods and apparatus. For example, drying the product immediately or shortly after harvest (e.g., at or near the harvest location) using the methods and apparatus described herein can preserve most or all of the nutritional properties of the harvested material. The drying process prolongs the product's shelf life and can eliminate the need for immediate refrigeration. This can significantly reduce the cost and effort associated with transporting and storing harvested materials. Further, the dried product contains less water and is therefore lighter than the harvested material and easier to transport.

In one aspect, the subject matter of this disclosure relates to a mobile drying system. The mobile drying system includes at least one portable platform where a refractance window dryer is disposed. The mobile drying system further includes a water supply system disposed on the at least one platform and configured to provide hot water to the refractance window dryer, and an air supply system disposed on the at least one platform and configured to provide hot air to the refractance window dryer.

In another aspect, the subject matter of this disclosure relates to a method of drying a plant product. The method includes providing a mobile drying system that includes at least one portable platform, a refractance window dryer disposed on the at least one platform, a water supply system disposed on the at least one platform and configured to provide hot water to the refractance window dryer and an air supply system disposed on the at least one platform and configured to provide hot air to the refractance window dryer. The method further includes drying a plant product in the refractance window dryer disposed on the at least one portable platform.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying figures, which are included as part of the present specification, illustrate the various embodiments of the presently disclosed system and method and together with the general description given above and the detailed description of the embodiments given below serve to explain and teach the principles described herein.

FIG. 1 illustrates an exemplary cutaway view of a mobile unit containing a refractance window dryer, according to one embodiment.

FIG. 2 illustrates an exemplary cutaway view of a mobile unit containing utility equipment for a refractance window dryer, according to one embodiment.

FIG. 3 illustrates an exemplary hot air supply system for a refractance window dryer, according to one embodiment.

FIG. 4 illustrates an exemplary liquid supply system for a refractance window dryer, according to one embodiment.

FIG. 5 illustrates an exemplary mixing and preheating system for a refractance window dryer, according to one embodiment.

FIG. 6 illustrates an exemplary refractance window dryer having multiple sections, according to one embodiment.

FIG. 7 illustrates an exemplary cleaning water system for a refractance window dryer, according to one embodiment.

FIG. 8 is a flowchart of an exemplary method of using a mobile drying system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the disclosure disclosed herein and do not limit the scope of the claims.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

A mobile drying system for drying a harvested plant product at or near a harvesting location using a mobile refractance window dryer is disclosed. The mobile drying system can include at least one portable platform and a refractance window dryer (alternatively referred to as a “dryer module”) disposed on the at least one portable platform. The mobile drying system can also include a water supply system disposed on the at least one portable platform and configured to provide hot water to the refractance window dryer. The mobile drying system can additionally include an air supply system disposed on the at least one portable platform and configured to provide hot air to the refractance window dryer.

According to one embodiment, the at least one portable platform can include two portable platforms. The refractance window dryer can be disposed on or in one of the portable platforms. Components that provide water, air, other materials, and/or power to the dryer can be disposed on or in the other portable platform.

Configuring the dryer and related equipment on two portable platforms in this manner can make the mobile drying system easier to transport. For example, transporting two smaller portable platforms may be easier than transporting one large portable platform, particularly when road conditions are poor. Alternatively or additionally, placing all necessary components for the mobile drying system on a single platform may not be feasible, considering component sizes and the available capacity of a mobile platform (e.g., a trailer).

According to some embodiments, refractance window drying can involve applying a product to a thin belt (e.g., a mylar belt) that floats on a heated medium (e.g., a hot water bath maintained at a predetermined temperature) and carries the product through a drying chamber. Heat from the heated medium is conducted through the belt and heats the product, which causes water in the product to evaporate. As the belt carries the product through the chamber, the amount of water in the product decreases until it reaches a limit (e.g., about 2%, about 3%, about 4%, about 5%, or other amount, by weight). At this point, there may no longer be enough water in the product to conduct heat from the belt and the drying “window” closes. The belt can then refract thermal energy back into the water until the product reaches an exit portion of the dryer.

In general, refractance window drying can be a safe and effective way to dehydrate freshly harvested products or slurries formed from such products (alternatively referred to herein as plant materials). The technique can extract water from harvested products while preserving vitamins, minerals, and micronutrients contained therein. The gentle nature of refractance window drying has several advantages over other dehydration methods such as spray drying or freeze drying. For example, the dried products can retain all the nutritional benefits of their fresh equivalents because the products are not exposed to extreme temperatures (e.g., compared to freeze drying) or high shear forces (e.g., compared to spray drying) that can damage the products.

A wide variety of harvested plant materials can be processed using the systems and methods described herein. The harvested plant materials can include, for example, grapes, carrots, beets, potatoes, radishes, peas, curcumin, corn, beans, algae, hemp, cannabis or any other harvested plant material, portion of a plant, or type of plant.

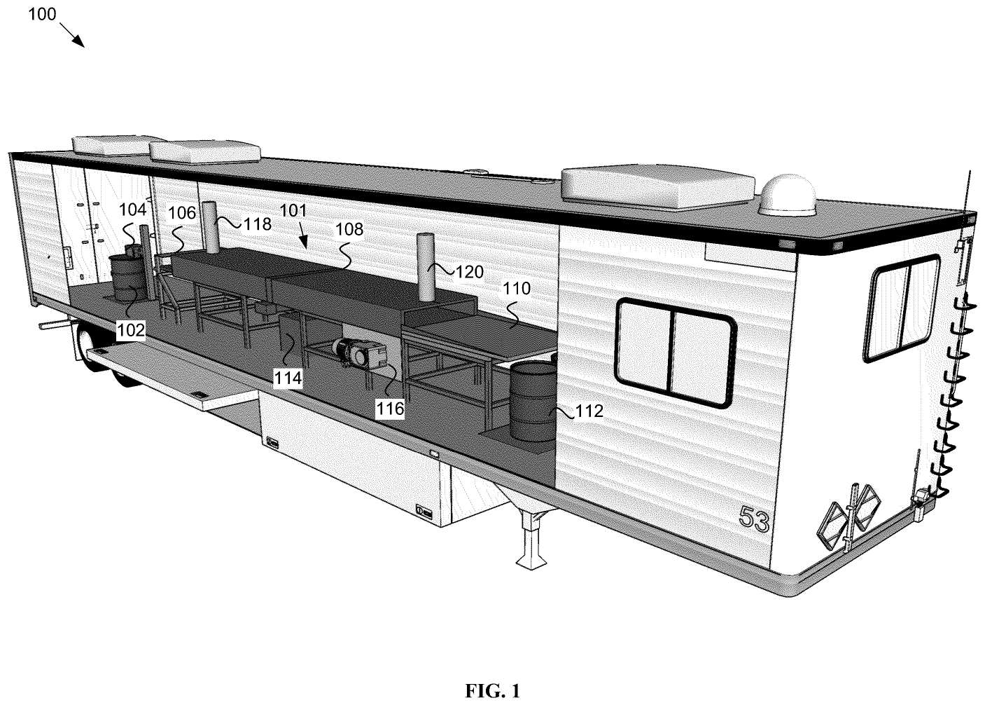

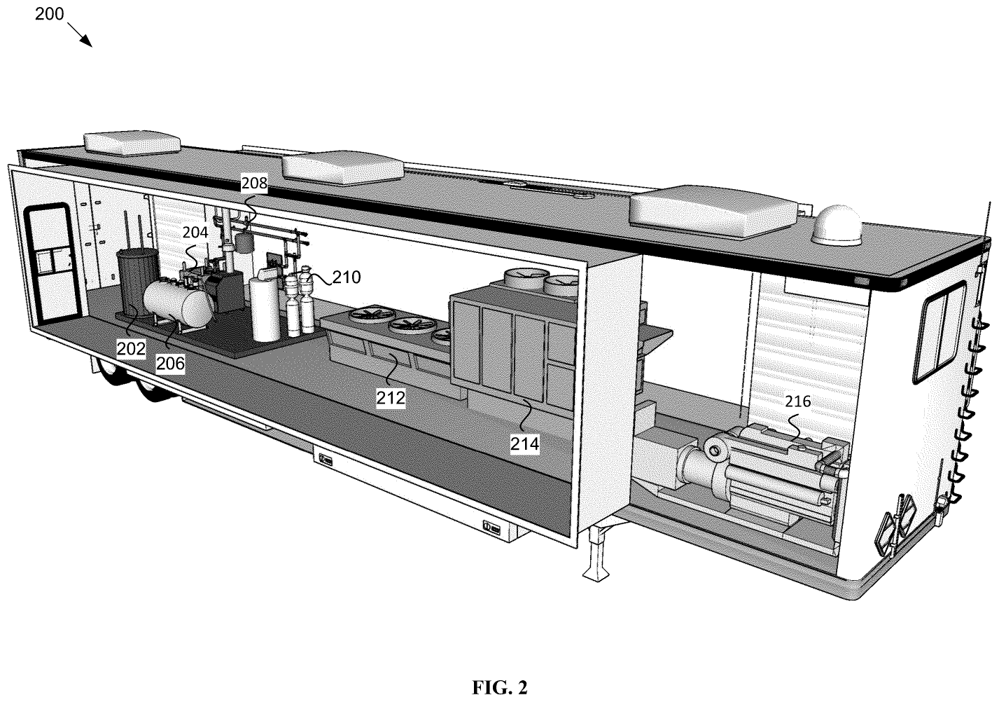

Examples of the first and second portable platforms (also referred to as mobile platforms or mobile units) are shown in FIGS. 1 and 2, respectively. Each mobile platform can be or include any type of platform that can be carried on or pulled or pushed by a vehicle. In one example, the first and/or second mobile platforms may have a width from about 50 inches (1.27 meters) to about 150 inches (3.81 meters), or about 100 inches (2.54 meters). Alternatively or additionally, the first and/or second mobile platforms may have a height from about 70 inches (1.78 meters) to about 150 inches (3.81 meters), or about 110 inches (2.79 meters). Alternatively or additionally, the first and/or second mobile platforms may have a length from about 30 feet (9.14 meters) to about 70 feet (21.33 m), or about 53 feet (16.15 meters). Other widths, heights, and/or lengths can be used. In some embodiments, the first and second platforms may have the same dimensions. In some embodiments, the first and second platforms may be different in size. While the two figures depict the first and second mobile platforms as trailers (e.g., containing wheels), it is understood that the first and second mobile platforms may be configured as transportable skid mounted assemblies or other mobile platforms or accessories (e.g., that can be placed on or carried by a trailer or vehicle).

In various examples, the first and second mobile platforms can be transported to any location where refractance window drying is desired to be performed. For example, the platforms can be transported to or near a field where plant materials are harvested. In certain instances, for example, the platforms can be positioned on the field or within about 10 meters, about 100 meters, about 1 km, or about 10 km of the field. The two platforms can be parked side-by-side (or end-to-end) and connected together with various wires, pipes, tubes, and/or conduits that permit power and/or materials to flow between the two platforms. Connectors can be provided that enable the wires, pipes, tubes, and/or conduits to be connected and disconnected between the two platforms, as needed. For example, flexible hoses with quick disconnects can be used for water lines, flexible ducts with quick disconnects can be used for air lines, and/or cable (e.g., SO cable) with quick disconnects can be used for power lines. In certain examples, one of the platforms includes a refractance window dryer and the other platform includes utility equipment for the dryer. When the two platforms are parked side-by-side, one or more walls can be removed and/or a door, bridge, and/or slideout can be provided between the two platforms, such that personnel and/or equipment can be moved between the two platforms. The two platforms can be secured together, as desired, with one or more mechanical fasteners, including bolts, hooks, and clamps.

FIG. 1 illustrates an example portable platform or mobile unit 100 that includes a refractance window dryer 101 and associated components, according to one embodiment. As illustrated, the components for the refractance window dryer 101 may include a feed container 102, a feed pump station 104, a feed section 106, a drying section 108, an exit cooling section 110, and a dried product container 112. The feed container 102 may contain fresh product (e.g., a slurry of harvested plant material) to be dried through a refractance window drying process. The feed pump station 104 may pump the product from the feed container 102 to the feed section 106, where the product is applied (e.g., as a film or layer) to a drying belt included in the drying section 108. The drying belt is driven by a belt drive 116 and carries the product through the drying section 108 where the product is dried.

After the drying section 108, the belt can carry the dried product through an exit cooling section 110 (also referred to as a “conditioning tray”) of the refractance window dryer 101. The cooling section 110 can help achieve separation of the dried product from the belt, as described herein. Once separated, the dried product may be collected in the dried product container 112, repackaged, stored, and/or transported to an offsite location.

As also illustrated in FIG. 1, in some embodiments, the refractance window dryer 101 may further include an air supply manifold 120 that is positioned above the drying belt and configured to deliver conditioned air to the drying section 108. The air supply manifold 120 can include one or more slits that inject conditioned air (e.g., hot air) across an entire width of the drying belt. The air can flow through the drying section 108 to an exhaust manifold 118 (e.g., located near the feed section 106), which can remove air and moisture from the drying section 108.

According to one embodiment, the conditioned air provided by the air supply manifold 120 can be air that has a predetermined humidity and temperature, which may be specific to the type of product being dried. According to another embodiment, the air injected into the drying chamber can be or include ambient air taken from outside the chamber or outside the mobile unit 100.

As also illustrated in FIG. 1, the first portable platform may further include a water tank 114 that holds hot water and/or other liquid provided for the heated medium used to warm the drying belt and the product. The water in the water tank 114 may have a predetermined temperature, which may be specific to the product being dried. The temperature may be just below the boiling point, such as, for example, about 208° F. (98° C.) or about 210° F. (99° C.).

FIG. 2 illustrates an example second portable platform or mobile unit 200 that includes utility equipment for a refractance window dryer (e.g., the dryer 101), according to one embodiment. The utility equipment may provide the conditioned air and/or the liquid for the heated medium (e.g., water) with a proper temperature and/or composition for use in the refractance window drying process. The conditioned air and liquid may be prepared in the second platform 200 and delivered to the refractance window dryer (e.g., dryer 101) in a separate portable platform (e.g., the first platform 100) via one or more tubes, pipes, ducts, or conduits.

According to some embodiments, the second platform 200 may include an incoming water reservoir 202, a hot water generator 204, a hot water tank 206, a water circulation system 208, a water conditioner 210, a water chiller 212, a hot air supplier 214, and optionally a power generator 216.

Referring to FIGS. 1 and 2, the water circulation system 208 may be connected with the water tank 114 disposed in the first platform 100. For example, hot water generated by the hot water generator 204 in the second platform 200 may be circulated by the water circulation system 208 to the water tank 114 for drying the product in the refractance window dryer 101. Water pipelines connecting the two platforms 100 and 200 may be detachably connected between the two platforms 100 and 200. One or more sensors may be disposed in the water tank 114 and used to control the hot water generator 204, for adjusting the temperature of the hot water supplied to the water tank 114.

The water chiller 212 may be used to cool water (or other coolant) to a low temperature (e.g., between about 40° F. (4° C.) and about 45° F. (7° C.)) before being delivered to the exit cooling section 110 in the first platform 100. The cooled water in the exit cooling section 110 may cool down the dried product and/or facilitate product separation from the drying belt, as described herein. The water chiller 212 may include a respective water circulation system for transporting cooled water from the water chiller 212 in the second platform 200 to the exit cooling section 110 in the first platform 100. Water pipelines in the cooled water circulation system may be detachably connected between the first platform 100 and the second platform 200.

The hot air supply 214 may generate conditioned air for evaporating water from the product during the refractance window drying process. Similar to the hot water or cooled water, the hot air generated by the hot air supply 214 may be transported to the air supply manifold 120 via pipes or ducts that may be detachably connected between the first platform 100 and the second platform 200. The air may flow through the drying chamber in the drying section 108 and exit the chamber through the exhaust manifold 118. The air can then flow out of the first platform 100 and back into the second platform, or into the environment, or may be directed toward a steam condensate tank, as described herein.

The power generator 216 may generate electrical power used by equipment on the first platform 100 and/or the second platform 200. The electrical power may be used, for example, by the drive belt 116, control systems, computer equipment, lighting, and/or one or more pumps for the hot water circulating system, the hot air circulation system, and/or the cooled water circulation system. The power generator 216 can be or include a diesel generator.

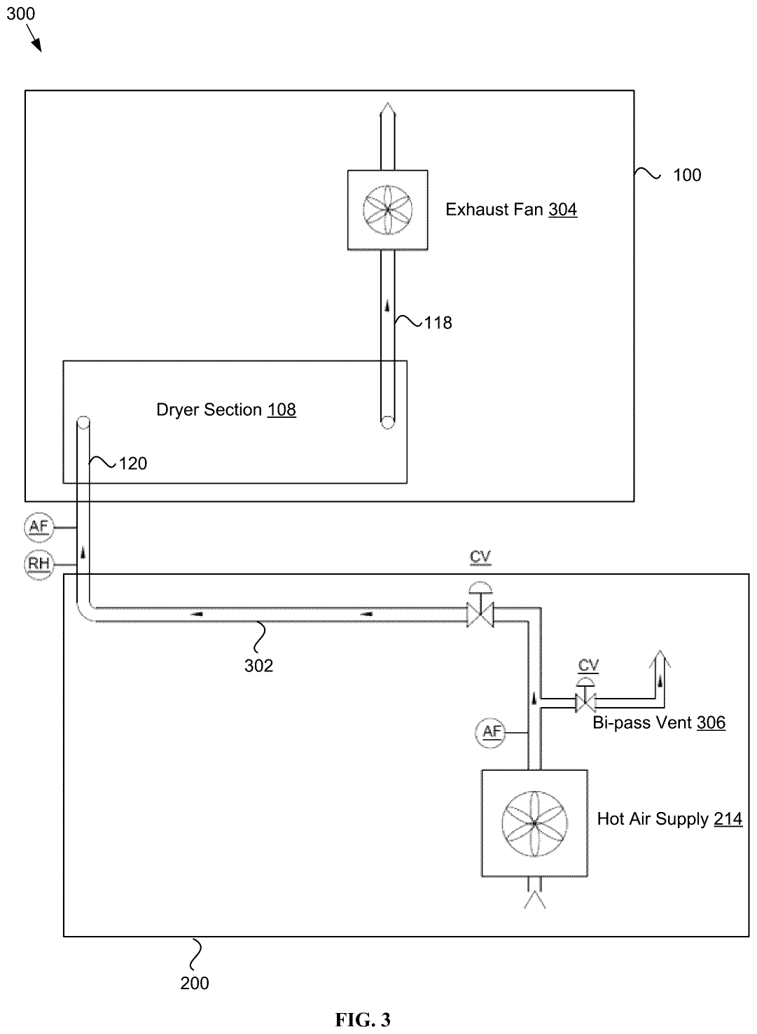

In some embodiments, the refractance window dryer and the supporting utility equipment may include additional components not described herein. Refractance window dryers and related equipment are described in U.S. Pat. Nos. 4,631,837, 8,790,717, 11,221,179, and 11,226,155, the entire contents of each of which are incorporated by reference herein. Additional details related to the utility equipment in the second platform 200 are described below with reference to FIGS. 3-7.

FIG. 3 is a schematic representation of hot air supply system 300, which provides hot or conditioned air to the refractance window dryer (e.g., dryer 101) described herein, according to one embodiment. The hot air is generated by the hot air supply 214 (e.g., in the second mobile unit 200) and is transported to dryer section 108 in the first mobile unit 100. In one example, the hot air supply 214 includes a heating, cooling, and air-conditioning (HVAC) unit fitted with a high-efficiency particulate air (HEPA) filter.

In some embodiments, the conditioned air is delivered from the hot air supply 214 to a first end of the dryer section 108 (e.g., air supply manifold 120) via one or more air lines 302. The air lines 302 can utilize a detachable connection between the two mobile units 100 and 200. This allows the air lines 302 on the mobile units to be disconnected when the mobile units 100 and 200 are separated from each other or being transported.

In certain examples, one or more valves and/or gauges may be included in the air lines 302 to control or monitor the flow of conditioned air provided by the hot air supply 214. Example valves or gauges may include adapter (AF) check value, reverse angle (RH) valve, and/or control valve (CV).

Additionally or alternatively, the one or more air lines 302 can be fitted with a bi-pass vent 306 to divert the conditioned air from the dryer section 108 when required. For example, when a refractance window drying session is completed, it may be desirable to release the conditioned air through the bi-pass vent.

According to some embodiments, the air in the dryer section 108 can carry moisture removed from the product through the dryer section 108 and to the exhaust manifold 118. An exhaust fan 304 coupled to the exhaust manifold 118 can create a slight negative pressure inside the dryer section 108 and/or can help discharge the air and moisture from the dryer section 108. According to some embodiments, the dryer section 108 can include a low-profile air tunnel system that achieves uniform air flow above the product being dried. The low-profile air tunnel system improves efficiency and can allow lower air flow rates to be utilized. In some examples, air flow rates through dryer can be from about 100 ft³/min (2.83 cubic meter/minute) to about 3,000 ft³/min (85.0 cubic meter/minute), or about 1500 ft³/min (42.5 cubic meter/minute).

Additionally or alternatively, the low-profile air tunnel system can allow the refractance window dryer and associated air flow equipment to be compact and fit in a mobile platform. For example, the dryer section 108 (e.g., enclosing the belt, water beneath the belt, and air space above the belt) can have a width from about 44 inches (1.18 meter) to about 84 inches (2.13 meter), or about 64 inches (1.63 meter). A height of the dryer section 108 can be from about 7 inches (0.18 meter) to about 15 inches (0.38 meter), or about 11 inches (0.28 meter). A length of the dryer section 108 can be from about 15 feet (4.57 meter) to about 25 feet (7.62 meter), or about 20 feet (6.10 meter). Other dimensions for the dryer section 108 are contemplated.

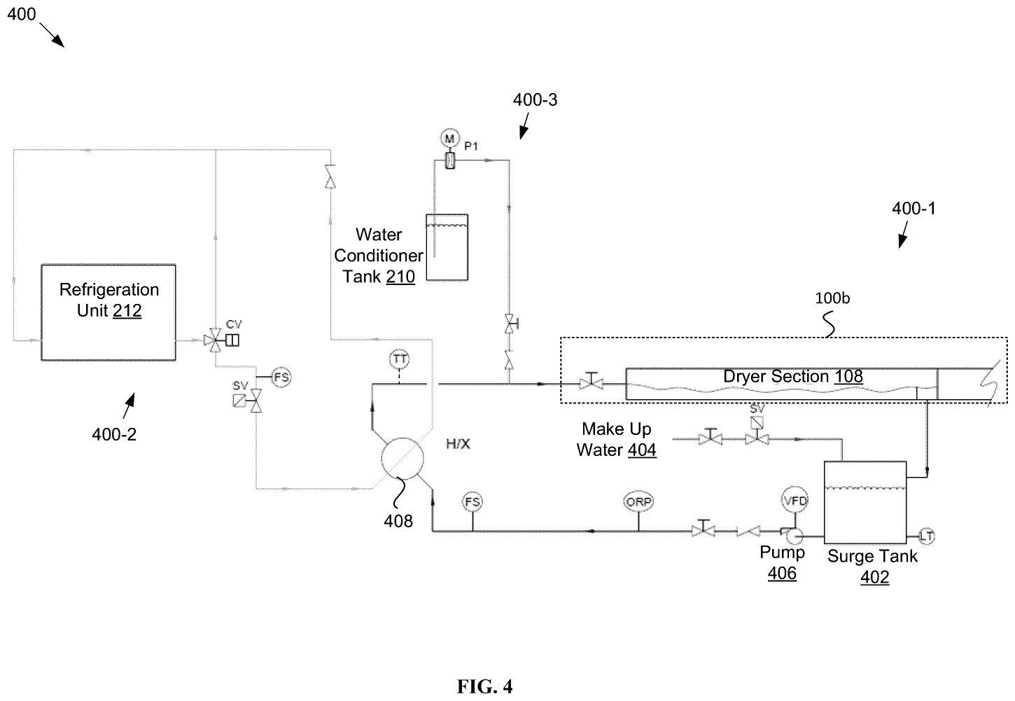

FIG. 4 is a schematic diagram of a liquid supply system 400 for the refractance window dryer system described herein, according to one embodiment. In general, the liquid supply system 400 may include three different portions: a first portion 400-1 for providing hot water for drying the product, a second portion 400-2 for providing cooled water for cooling the product, and a third portion 400-3 for cleaning or conditioning the water and/or providing one or more additives to the water.

As described herein, during a refractance window drying process, hot water is directed underneath a moving conveyer belt in the dryer section 108 (shown in dotted box 100b in FIG. 4) to dry the freshly harvested product. To provide the hot water, the first portion 400-1 of the liquid supply system 400 may include a surge tank 402 (e.g., the hot water tank 206), a fresh water supply 404 (e.g., the water reservoir 202, for replenishing the water) coupled to the surge tank 402, a water pump 406, a heat exchanger 408, and a series of valves and/or gauges. The water pump 406 may pump hot water from the surge tank 402 to the dryer section 108. The series of valves and/or gauges may include, for example, a flow switch (FS), an oxidation-reduction potential (ORP) electrode, a temperature transmitter (TT), a level transmitter (LT), and/or a digital vacuum florescent display (VFD) gauge. The heat exchanger 408 is optional and can be used to transfer heat between the first portion 400-1 and the second portion 400-2.

The second portion 400-2 of the liquid supply system 400 may include a refrigeration unit 212 configured to provide cooled water to an exit section (e.g., exit cooling section 110) of a refractance window dryer, to facilitate separation of the dried product from the drying belt. According to some embodiments, the belt and the product carried thereon may undergo a thermal shock when transitioning from the dryer chamber (e.g., dryer section 108) to the exit cooling section. For example, differences in thermal expansion coefficients between the belt and the product can cause the product to separate from the belt and/or can allow the product to be easily scraped off of the belt.

In some examples, the water in the liquid supply system 400 may include one or more additives, such as glycol, which can prevent corrosion and/or provide improved heat transfer characteristics. For example, a glycol solution can be used to heat the belt in the dryer chamber and/or cool the belt in the exit cooling section.

The third portion of the liquid supply system 400 may include the water conditioner tank 210, as described earlier. The water conditioner tank 210 can provide certain additives to the water, for example, to prevent mold, slime, and/or undesirable organic growth. In one example, the water conditioner tank 210 can introduce bromine, chlorine, or similar disinfectants. The second portion 400-2 and the third portion 400-3 of the liquid supply system 400 may include certain valves and/or gauges.

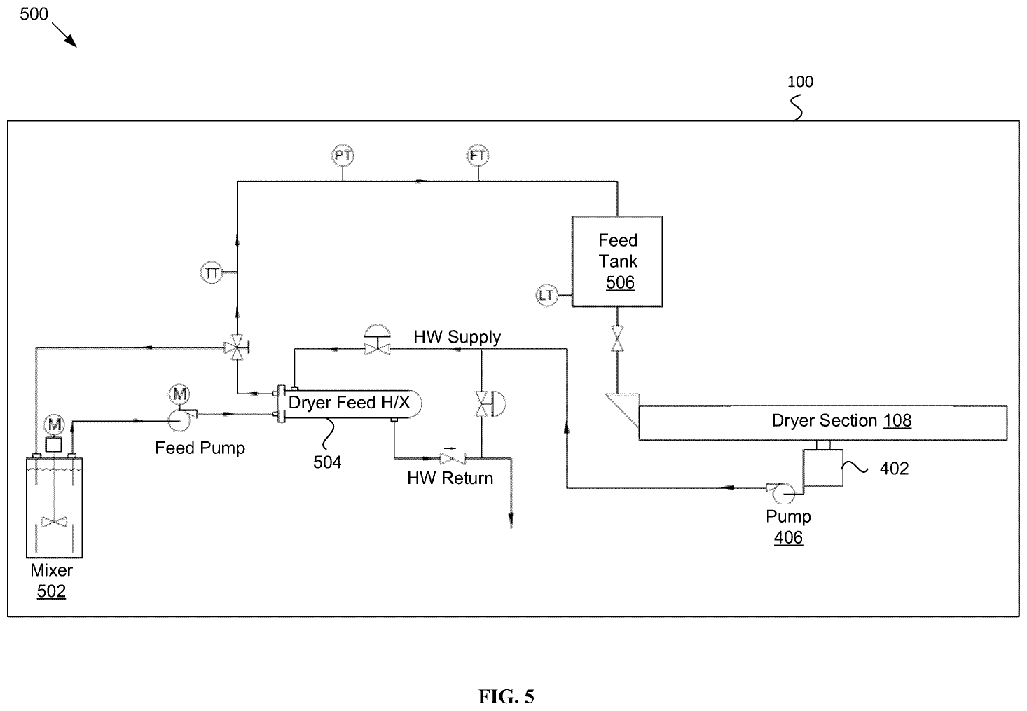

FIG. 5 is a schematic diagram of a continuous mixing and preheating system 500 for the refractance window dryer (e.g., dryer 101), according to one embodiment. In some embodiments, the product to be dried may be blended and/or preheated before being fed into the dryer, to improve drying efficiency. For example, the system 500 may include a mixer 502 and a heat exchanger 504 or other preheating device located in or near a feeding section (e.g., feed section 106) of the refractance window dryer. According to some embodiments, the mixer 502 and the heat exchanger 504 may be located in the first mobile unit 100. The mixer 502 may be used to convert a harvested product into a slurry and/or maintain the slurry in a substantially homogenized state. The slurry may be pumped from the mixer 502 to the heat exchanger 504, where the slurry is preheated before being provided to a feed tank 506. The heat exchanger 504 can transfer heat from hot water used to heat the belt and product in the dryer. For example, at least a portion of the hot water can be pumped through the heat exchanger 504 to preheat the slurry. In various examples, a roller, a blade, an extruder, or other coating device can receive the slurry from the feed tank 506 and apply the slurry to the belt in the drying section 108.

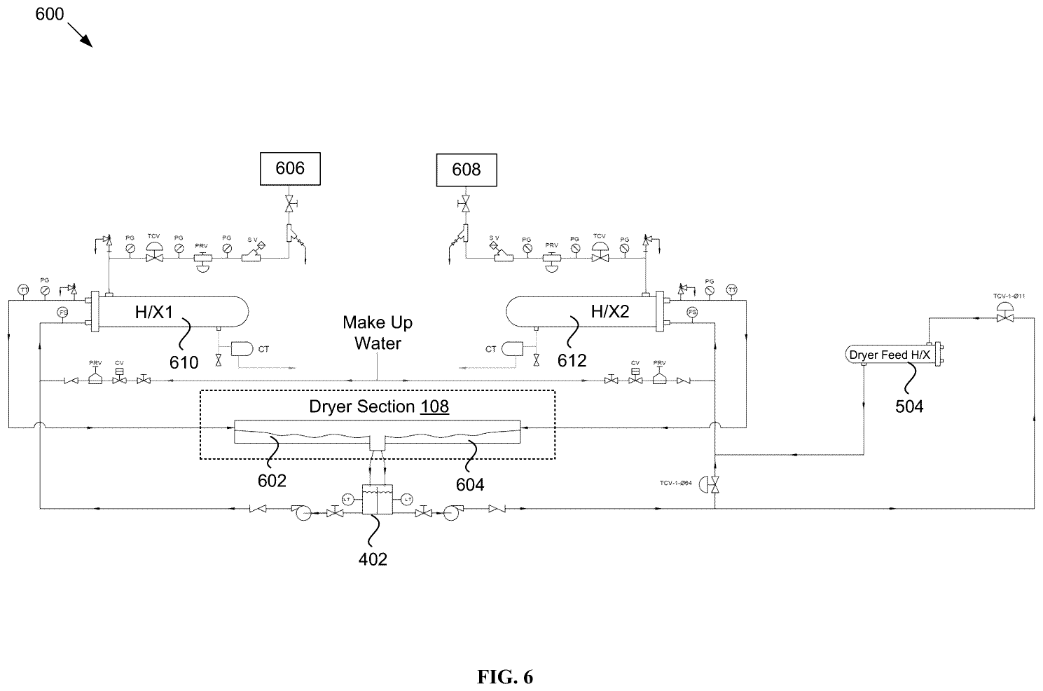

FIG. 6 is a schematic diagram of a refractance window drying system 600 in which the dryer section 108 includes two hot water sections having different water temperatures, in accordance with certain embodiments. In some implementations, a first section 602 (e.g., positioned closer to the dryer feed) may have a water temperature that is lower than the water temperature in the second section 604 (e.g., closer to the dryer exit). The different temperatures may result in a more gentle drying process. In some examples, the water temperature in the first section 602 may be lower than the water temperature in the second section 604 by, for example, from about 3.6° F. (2° C.) to about 36° F. (20° C.), or about 18° F. (10° C.). Other temperature differences can be used. To achieve the different water temperatures, each section 602 and 604 may have its own respective heat source 606 and 608. Heat may be supplied in the form of steam and/or may be derived by burning oil, gas, or other fuel source. Other sources of heat are contemplated. In the depicted example, the heat sources 606 and 608 include steam, which is passed through heat exchangers 610 and 612 to heat the water for each section 602 and 604. The surge tank 402 can include separate zones that store water for each of the sections 602 and 604. The dryer section 108 can include a divider or baffle that separates the two sections 602 and 604 and prevents water from flowing between the two sections 602 and 604. While the depicted example includes two sections 602 and 604, it is understood that additional sections can be included, for example, with each section configured for independent water temperature control.

By way of example and not limitation, the water coming out of the heat exchanger 612 for the second section 604 may have a temperature of about 210° F. (99° C.), while the water returning to the surge tank 402 for the second section 604 may have a temperature of about 190° F. (88° C.). In such instances, the heat exchanger 612 may increase the temperature of the returning water by about 20° F. (11° C.).

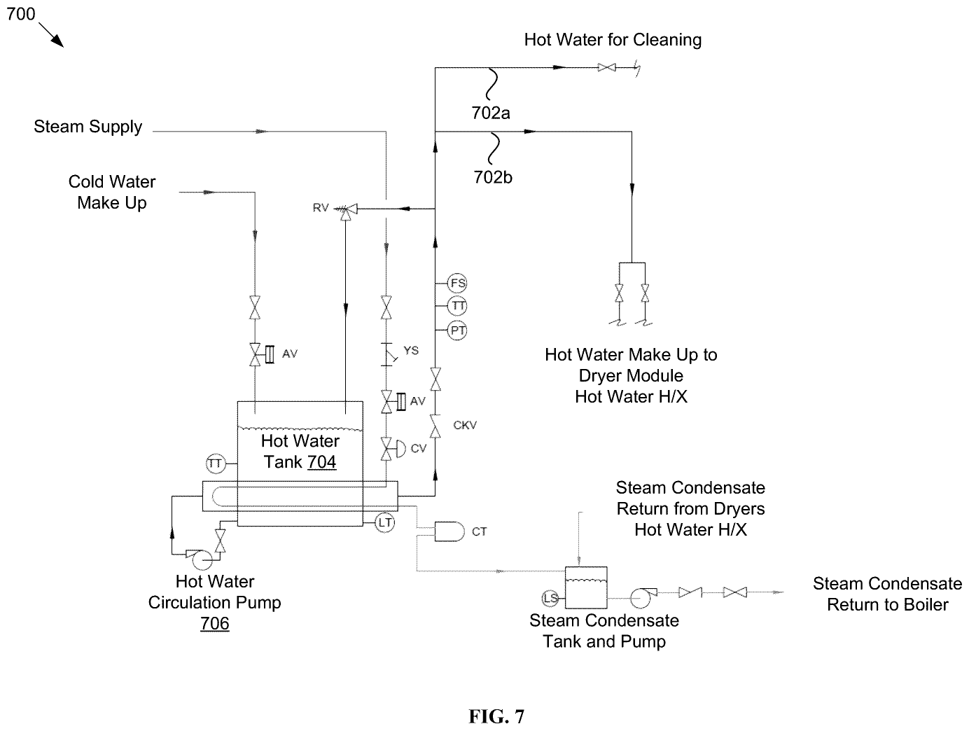

FIG. 7 is a schematic diagram of a hot water supplying system 700 that includes a water line 702a configured for cleaning the system components described herein, according to one embodiment. The water line 702a may be connected to a hot water tank 704 (which may be the same as or different from the surge tank 402) through a hot water circulation pump (which may be the same as or different from the pump 406). In the depicted example, the hot water is produced using steam, although other heat sources may be used (e.g., electricity, oil, propane, etc.). For example, a steam heat source may be pumped through a heat exchanger, which transfers heat from the steam to the water in the tank 704. A portion of the steam may be condensed to liquid water during the process, which can be recirculated to a boiler for reproducing the steam. The hot water supplying system 700 may include a hot water line 702b to make up for any water that leaves the system 700, for example, due to evaporation.

In some embodiments, the hot water in line 702a used for cleaning purposes may have a temperature from about 120° F. (49° C.) to about 135° F. (57° C.) and/or may be pressurized in the line 702a from about 45 psi (310,264 pascals) to about 60 psi (413,685 pascals). A pump 706 may recirculate water through the tank 704.

In certain examples, the mobile drying system disclosed herein may include one or more sensors and one or more controllers for controlling the refractance window dryer and associated equipment. For example, one or more sensors may be included to measure the temperature, pressure, and/or composition of the water and air used by the dryer and system components. Sensor signals can be provided to controllers for automatic control of pumps, blowers, motors, heating equipment, cooling equipment, and/or any other system components.

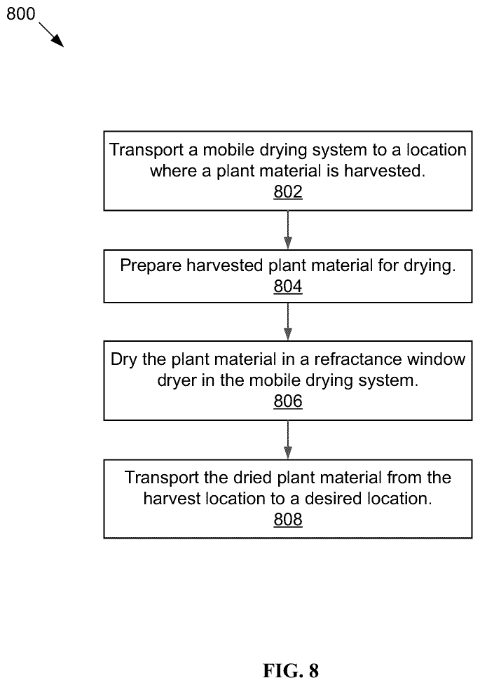

FIG. 8 is a flowchart of an exemplary method 800 of using a mobile drying system, according to one embodiment. At step 802, the mobile drying system is transported to a location where a plant material is harvested. The mobile drying system includes a refractance window dryer and supporting utility equipment. The dryer can be disposed on one mobile unit and one or more components that support the dryer can be disposed on a separate mobile unit, for example, as described above with respect to FIGS. 1 and 2. At step 804, a harvested plant material is prepared for drying by, for example, converting the harvested plant material into a slurry. At step 806, the harvested plant material is dried in the mobile drying system at the location where the plant material was harvested. At step 808, the dried plant material is transported from the harvest location to a different location where the dried plant material can be stored and/or subjected to further processing.

The above example embodiments have been described herein above to illustrate various embodiments of implementing a mobile drying system including a refractance window dryer and supporting utility equipment disposed on at least one mobile unit. Various modifications and departures from the disclosed example embodiments will occur to those having ordinary skill in the art. The subject matter that is intended to be within the scope of the present disclosure is set forth in the following claims.

### Terminology

The phraseology and terminology used herein is for the purpose of description and should not be regarded as limiting.

The term “approximately”, the phrase “approximately equal to”, and other similar phrases (e.g., “about”), as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims,

unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A mobile drying system comprising:
at least one portable platform;
a refractance window dryer disposed on the at least one platform;
a water supply system disposed on the at least one platform and configured to provide hot water to the refractance window dryer; and
an air supply system disposed on the at least one platform and configured to provide hot air to the refractance window dryer.

2. The mobile drying system of claim 1, wherein the at least one platform comprises a first platform and a second platform, wherein the first platform is disposed on a first vehicle or a first trailer, and wherein the second platform is disposed on a second vehicle or a second trailer.

3. The mobile drying system of claim 2, wherein the refractance window dryer is disposed on the first platform and at least a portion of the water supply system or the air supply system is disposed on the second platform.

4. The mobile drying system of claim 2, wherein the first platform and the second platform are connected to one other with at least one of a water line, an air line, or a power line.

5. The mobile drying system of claim 1, wherein the refractance window dryer comprises a drying chamber comprising a belt and at least one hot water tank disposed under the belt.

6. The mobile drying system of claim 5, wherein the refractance window dryer further comprises an exit cooling section.

7. The mobile drying system of claim 6, wherein the water supply system is further configured to provide a cooled solution to the exit cooling section.

8. The mobile drying system of claim 7, wherein the cooled solution comprises water.

9. The mobile drying system of claim 8, wherein the cooled solution further comprises a glycol compound.

10. The mobile drying system of claim 1, wherein the water supply system further comprises a tank for holding a cleaning agent.

11. The mobile drying system of claim 10, wherein the cleaning agent comprises a bromide solution.

12. The mobile drying system of claim 1, wherein the refractance window dryer comprises a first hot water section and a second hot water section, the first hot water section comprising a first temperature and the second hot water section comprising a second temperature.

13. The mobile drying system of claim 12, wherein the refractance window dryer comprises a feed section, and wherein the feed section is closer to the first hot water section than the second hot water section, and wherein the first temperature is lower than the second temperature.

14. The mobile drying system of claim 1, wherein the water supply system further comprises a water line configured for cleaning one or more components of the mobile drying system.

15. The mobile drying system of claim 1, wherein the refractance window dryer further comprises a mixer for preparing a product to be dried.

16. The mobile drying system of claim 1, further comprising a generator to provide power for at least one of the refractance window dryer, the water supply system, or the air supply system.

17. A method of drying a plant product, the method comprising:
providing a mobile drying system comprising:
at least one portable platform;
a refractance window dryer disposed on the at least one platform;
a water supply system disposed on the at least one platform and configured to provide hot water to the refractance window dryer; and
an air supply system disposed on the at least one platform and configured to provide hot air to the refractance window dryer; and
drying a plant product in the refractance window dryer.

18. The method of claim 17, wherein the mobile drying system is positioned at or near a location where the plant product is harvested.

19. The method of claim 17, wherein the plant product comprises a slurry containing plant material.

20. The method of claim 17, wherein drying the plant product comprises applying the plant product to a belt in the refractance window dryer.
